(19) United States
(12) Patent Application Publication
(10) Pub. No.: US 2003/0003024 A1
(43) Pub. Date: Jan. 2, 2003

(54) Chip reactors having at least two different microreaction channels

(76) Inventors: Torsten Zech, Heidelberg (DE); Dieter Hoenicke, Karlsruhe (DE)

Correspondence Address: COGNIS CORPORATION, 2500 RENAISSANCE BLVD., SUITE 200, GULPH MILLS, PA, 19406

(21) Appl. No.: 10/075,726

(22) Filed: Feb. 14, 2002

(30) Foreign Application Priority Data
Feb. 15, 2001 (DE) 101 06 952.9

(51) Int. Cl. G01N 1/20; G01N 1/18

(52) U.S. Cl. 422/100; 422/58; 422/99; 436/180; 435/287.3; 435/288.5

(57) ABSTRACT

Chip reactors which comprise a carrier having at least two different microreaction channels, each of the channels comprising at least one reaction space, at least one inlet and at least one outlet, wherein each of the channels is suitable for operation independent of the other are described.

### BACKGROUND OF THE INVENTION

Microstructure reactors are known among experts to be microstructure apparatus for chemical processes of which the characteristic is that at least one of the three spatial dimensions of the reaction space is 1 to 2000 μm in size and which are therefore distinguished by a large transfer-specific inner surface, short residence times of the reactants and high specific heat and mass transport levels. Reference is made by way of example to European patent application EP 0903174 A1 (Bayer) which describes the liquid-phase oxidation of organic compounds in a microreactor consisting of a host of parallel reaction channels.

Microreactors may additionally contain microelectronic components as integral constituents. In contrast to known microanalysis systems, there is no need in the case of microreactors for all lateral dimensions of the reaction space to be in the μm range. Instead, its dimensions are determined solely by the nature of the reaction. Accordingly, certain reactions may even be carried out in microreactors where a certain number of microchannels are grouped together so that microchannels and macrochannels or parallel operation of a plurality of microchannels can be present alongside one another. The channels are preferably disposed parallel to one another to achieve a high throughput and to minimize the pressure loss.

Microreactors may assume many different forms, i.e. may differ in the geometric arrangement of the reaction spaces, their geometric dimensions and the nature of other functional elements, for example static mixers. It is of course clear to the expert that the particular form of the microreactor has a direct bearing on the yield and selectivity of the reaction. However, in order to determine the most suitable form of microreactor for each reaction, it has hitherto only been possible to test each one of the known, individually present microreactors which is naturally very time-consuming.

Accordingly, the problem addressed by the present invention was to remedy this situation and to provide a structural component with which the optimal form of a microreactor and suitable reaction conditions could be determined in a very short time and with minimal outlay on hardware.

### SUMMARY OF THE INVENTION

The present invention relates to a chip reactor consisting of a carrier with at least two different forms of microreaction system (“channels”) which each comprise at least one microreaction space, at least one inlet for the educts and at least one outlet for the products and which can be operated or used independently of one another.

The essence of the invention is that it combines a number of possible forms of microreactor in one miniaturized structural component in an exemplary manner. In this connection, “form” means above all the geometric arrangement of the microreaction systems or reaction spaces (preferably channels) and their geometric dimensions and also the way in which and the geometric site at which the reactants are mixed. Other variables include the possibility of differently cooling or heating the reaction in zones. It is possible in this way to vary a number of process parameters such as, for example, the educt concentration, the quantity ratio of the educts to one another, the use of solvents and other auxiliaries, the throughputs, the residence time, different residence times in individual zones and the reaction temperatures in the individual zones.

Accordingly, the new chip reactor makes it possible—by problem-free actuation of the individual microreaction spaces—to test a number of possible forms of microreaction systems for their suitability for liquid-phase reactions and optimization of the test results so that a number of experiments can be carried out far more quickly and with less outlay.

### BRIEF DESCRIPTION OF THE SEVERAL VIEWS OF THE DRAWING

FIG. 1 is an enlarged diagrammatic view of a chip reactor in accordance with a preferred embodiment of the present invention.

FIG. 2 is a cross-sectional diagrammatic view of a chip reactor embedded in a manifold in accordance with another preferred embodiment of the present invention.

### DETAILED DESCRIPTION OF THE INVENTION

### Chip Reactor

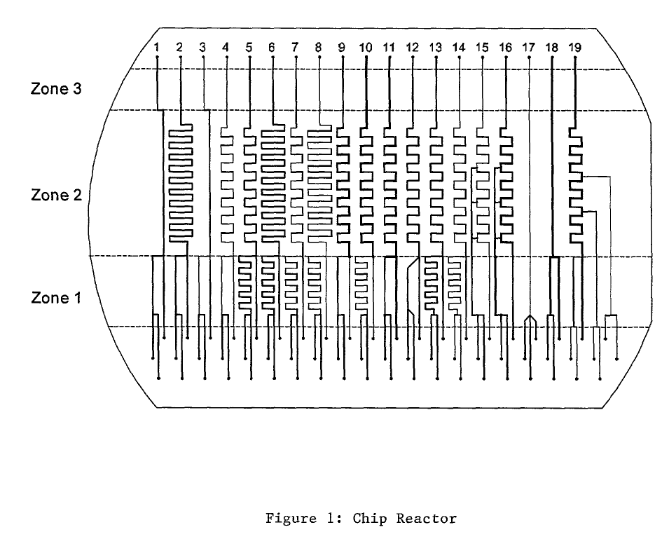

In one preferred embodiment, the chip reactor is a silicon/glass composite in which the structure and dimensions of the microreaction systems are determined in advance. Alternative material combinations are silicon/silicon, glass/glass, metal/metal, metal/plastic, plastic/plastic or ceramic/ceramic. One example of a layout with 19 channel structures is shown in FIG. 1. However, chips with up to 100, preferably 5 to 50 and more preferably 10 to 25 channels are possible. The structuring of the 100 to 2000 μm and preferably about 400 μm thick silicon wafer is preferably carried out by suitable microstructuring or etching techniques, for example reactive ion etching, by which three-dimensional structures can be produced in the silicon irrespective of the crystal orientation [cf, James, et al., Sci. Am. 4, 248 (1993)]. The structures are distinguished by dimensions of 50 to 1500 μm and preferably 10 to 1,000 μm and by vertical walls, the depth of the channels being from 20 to 1800 and preferably about 200 to 500 μm. The cross-sections of a microreaction space which can differ from one another according to the invention are of the order of 20×20 to 1500×1500 μm and more particularly 100×100 to 300×300 μm which Burns et al. also describe as typical in Trans IchemE, 77(5), 206 (1999). To supply the microreaction spaces with reactants, the silicon wafer is etched through at the intended places. After the structuring of the silicon wafer, it has proved to be of advantage in special embodiments to produce a compact SiO₂ layer on the surface of the reaction spaces or channels. This SiO₂ layer should have a thickness of preferably 50 to 2,000, more preferably 100 to 100 and most preferably about 200 to 400 nm. The SiO₂ layer ensures that the educts or products do not interact with the Si surface so that there are none of the unwanted secondary or even decomposition reactions which are otherwise often observed. The thermal coating of a silicon wafer with SiO₂ is carried out by heating the wafer to ca. 1,000° C. in an oxygen-containing atmosphere. This leads to a reaction between silicon and oxygen which in turn produces an oxide layer over the entire exposed surface, i.e. in particular even in the channel microstructures. The thickness of the SiO₂ layer can be adjusted through the duration of the heat treatment. The oxidation is a rooting process, i.e. the SiO₂ layer as it were grows into the wafer, and comes to a stop at a certain depth because no more silicon is available for oxidation. The process is suitable for producing very compact SiO₂ layers whose adhesion is excellent because they are intergrown with the silicon. In addition, the wafer remains bondable, i.e. it can be bonded to other wafers, for example of glass or Si. In general, other coating processes, for example physical vapor deposition, are also suitable providing the material remains bondable. Finally, the structured silicon wafer rendered inert by coating is bonded to another wafer, for example of glass, preferably Pyrex glass, by a suitable process, for example anodic bonding, and the individual flow channels are tightly closed relative to one another.

In another preferred embodiment of the invention, the chip reactor is divided into one or more mixing zones, one or more reaction zones, one or more mixing and reaction zones, one or more cooling zones or any combinations thereof The chip reactor preferably has three zones, namely two reaction zones and one cooling zone, so that in this case a two-stage liquid-phase reaction can be efficiently investigated. Two reactants are mixed and reacted in the first zone, the reaction between the product of the first zone and another educt takes place in the second zone and the reaction is terminated in the third zone by lowering the temperature. It is not absolutely essential strictly to separate the first and second reaction zones thermally from one another. This is because, if another reactant has to be added or if several mixing points rather than one are required, this can be done beyond zone 1 in reaction zone 2. Examples of this can be found in channels 16 and 19 in FIG. 1. The microreaction systems can be operated sequentially or simultaneously, i.e. in parallel with defined quantities of educt.

Another respect in which the microreaction systems can differ in their geometry is the mixing angle at which the educts impinge on one another and which can be between 15 and 270° and is preferably between 45 and 180°. In addition, each of the three zones can be cooled or heated independently of the others or the temperature in one of the zones can be varied, the reaction spaces in this example representing channels between 10 and 500 mm in length per zone. The geometries of the channel systems shown in FIG. 1 are explained in more detail in Table 1.

TABLE 1
Characterization of the channel systems shown in FIG. 1

| | Zone 1 | | | Zone 2 | | |
|---|---|---|---|---|---|---|
| | Channel | | | Channel | | |
| | length | Channel | Mixing | length | Channel | Mixing |
| Channel | mm | width μm | angle ° | mm | width μm | angle ° |
| 1 | 10 | 75 | 90 | 25 | 75 | 90 |
| 2 | 10 | 75 | 90 | 100 | 75 | 90 |
| 3 | 10 | 150 | 90 | 25 | 150 | 90 |
| 4 | 10 | 150 | 90 | 50 | 10 | 90 |
| 5 | 30 | 75 | 90 | 50 | 75 | 90 |
| 6 | 30 | 75 | 90 | 100 | 75 | 90 |
| 7 | 30 | 150 | 90 | 50 | 150 | 90 |
| 8 | 30 | 150 | 90 | 100 | 150 | 90 |
| 9 | 10 | 150 | 90 | 50 | 300 | 90 |
| 10 | 30 | 150 | 90 | 50 | 300 | 90 |
| 11 | 10 | 300 | 90 | 50 | 300 | 90 |
| 12 | 10 | 75 | 45 | 50 | 75 | 45 |
| 13 | 30 | 75 | 180 | 50 | 75 | 180 |
| 14 | 30 | 150 | 180 | 50 | 150 | 180 |
| 15^{a)} | 10-25 | 150 | 90 | 50 | 150 | 90 |
| 16^{a)} | 10-25 | 300 | 90 | 50 | 300 | 90 |
| 17^{b)} | — | — | — | 35 | 150 | 45 |
| 18 | 10 | 300 | 180 | 25 | 300 | 180 |
| 19^{c)} | 10/20/30 | 3 × 150 | 3 × 180 | 50 | 300 | 90 |

^{a)}three-stage addition
^{b)}common mixing point for three educts
^{c)}three independent systems

### Sandwich Construction

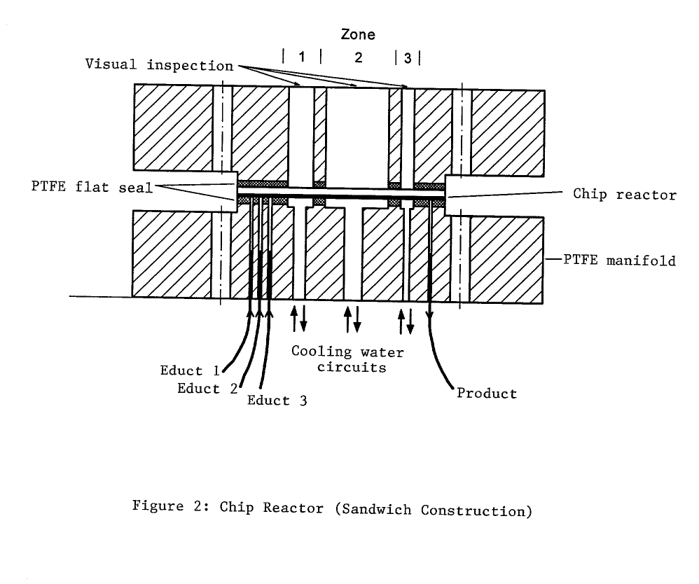

In one particular embodiment, the chip is made up into the complete chip reactor on the sandwich construction principle illustrated in FIG. 2. In this case, the chip is embedded in a manifold of a suitable, preferably inert material, for example PTFE, which underneath has inlets for the educts and outlets for the products and, on top, facilities for visual inspection—and hence for online reaction monitoring—through the glass wafer onto the various zones. The chip is covered on both sides with a flat seal, for example of the material Gore-tex® GR10. The manifold for the educt inlets and product outlets additionally contains channels for the passage of heat carrier liquids. Heat transfer takes place by the heat carrier flowing over the back of the silicon wafer through the chip reactor and hence effectively transferring the heat of reaction which is formed or necessary in the reaction channels. Each zone of the wafer can be exposed to another heat carrier. Basically, the temperature may also be regulated in any other way, for example by electrical heating. The temperatures in the individual zones may be adjusted independently of one another. The heat carrier is connected to the reactor manifold by hose connectors for example. The chip reactor has typical dimensions of 50×50 to 150×150 mm. The fluid connections to the chip reactor may also assume different forms, for example press fits of corresponding fluid lines onto the wafer (as presented by Schwesinger, 4th International Conference on Microreaction Technology, Atlanta, Ga., Mar. 5th-9th, 2000) or even adhesive bonds, possibly including small nozzles.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A chip reactor comprising a carrier having at least two different microreaction channels, each of the channels comprising at least one reaction space, at least one inlet and at least one outlet, wherein each of the channels is suitable for operation independent of the other.

2. The chip reactor according to claim 1, wherein the carrier comprises a silicon/glass composite.

3. The chip reactor according to claim 2, wherein at least a portion of the channels is etched.

4. The chip reactor according to claim 2, wherein at least a portion of the at least one reaction space is coated with silicon dioxide.

5. The chip reactor according to claim 4, wherein the silicon dioxide has a thickness of from 50 to 2000 nm.

6. The chip reactor according to claim 1, wherein the carrier has from 2 to 100 different microreaction channels, each of the channels comprising at least one reaction space, at least one inlet and at least one outlet, wherein each of the channels is suitable for operation independent of the other.

7. The chip reactor according to claim, 1, wherein each of the reaction spaces comprises a channel having a length of from 1 to 500 mm.

8. The chip reactor according to claim 1, wherein the reaction spaces have one or more mixing points.

9. The chip reactor according to claim 1, wherein at least one of the channels has at least two inlets, the at least two inlets impinging on each other at a mixing angle of from 15° to 270°.

10. The chip reactor according to claim 1, wherein at least one of the reaction spaces has one or more mixing points.

11. The chip reactor according to claim 1, wherein the chip reactor is divided into two or more zones for variable processing.

12. The chip reactor according to claim 11, wherein the two or more zones can be heated/cooled independently of one another.

13. The chip reactor according to claim 1, wherein the carrier is embedded in a manifold having an inbound passageway corresponding to the at least one inlet and an outbound passageway corresponding to the at least one outlet.

14. The chip reactor according to claim 13, wherein the manifold comprises an inert material.

15. The chip reactor according to claim 13, wherein the manifold further comprises at least one passageway for a heat transfer liquid.

16. The chip reactor according to claim 13, wherein the manifold further comprises a facility for visual inspection of the chip reactor.

17. The chip reactor according to claim 13, further comprising a seal separating the chip reactor from the manifold.

18. The chip reactor according to claim 1, wherein the carrier has at least three different microreaction channels, each of the channels comprising at least one reaction space, at least one inlet and at least one outlet, wherein each of the channels is suitable for operation independent of the other.

19. The chip reactor according to claim 1, wherein the carrier has from 5 to 50 different microreaction channels, each of the channels comprising at least one reaction space, at least one inlet and at least one outlet, wherein each of the channels is suitable for operation independent of the other.

20. A chip reactor comprising a silicon/glass composite carrier having from 5 to 50 different microreaction channels etched therein, each of the channels comprising at least one reaction space, a portion of which is coated with silicon dioxide having a thickness of from 50 to 2000 nm, at least one inlet and at least one outlet, wherein each of the channels is suitable for operation independent of the other, and wherein the carrier is embedded in an inert manifold having an inbound passageway corresponding to each inlet, an outbound passageway corresponding to each outlet, at least one passageway for a heat transfer liquid and a facility for visual inspection of the chip reactor.
